(19) United States
(12) Patent Application Publication
(10) Pub. No.: US 2019/0228411 A1
(43) Pub. Date: Jul. 25, 2019

(54) METHODS AND SYSTEMS FOR IMPROVING MERCHANT DATA

(71) Applicant: First Performance LLC, Atlanta, GA (US)

(72) Inventors: William M. Hernandez-Ellsworth, Atlanta, GA (US); Sosh A. Howell, Atlanta, GA (US); Walter G. Ley, Atlanta, GA (US)

(21) Appl. No.: 16/250,434

(22) Filed: Jan. 17, 2019

Related U.S. Application Data
(60) Provisional application No. 62/620,702, filed on Jan. 23, 2018.

(51) Int. Cl. G06Q 20/40; G06Q 20/08; G06F 16/22

(52) U.S. Cl. CPC G06Q 20/40; G06F 16/22; G06Q 20/085

(57) ABSTRACT

A method including receiving a merchant authorization message; extracting from the merchant authorization message, the merchant name and the merchant category code; retrieving location data from a first database; identifying and removing, from the merchant authorization message, a system identification and a payment terminal type; retrieve a plurality of entries; determine, for each of the plurality of entries, a relevance score; sort, based on the determined relevance scores, each of the plurality of retrieved entries; associate, with the updated merchant name, a particular entry of the plurality of entries having the highest relevance score; generate a dataset; comparing the merchant category data to a pre-defined list of merchant categories; updating the merchant category data; determining a merchant category similarity score; responsive to the merchant category data having a merchant category similarity score above a predetermined threshold, updating the merchant category field; and outputting, for transmission, the dataset to the device.

### CROSS-REFERENCE TO RELATED APPLICATION

This Application claims the benefit, under 35 U.S.C. § 119(e), of U.S. Provisional Patent Application No. 62/620,702, filed Jan. 23, 2018, the contents of which are hereby incorporated by reference herein in their entirety as if fully set forth below.

### FIELD

The presently disclosed subject matter relates generally to improving merchant data and, more particularly, to systems and methods for improving merchant data associated with a merchant authorization message.

### BACKGROUND

Cards (e.g., credit cards, debit cards, rewards cards, virtual cards) are powerful tools enabling cardholders to access financial power with much greater convenience. Unfortunately, as the use of payment cards becomes more widespread, so does the opportunity for their misuse. Security measures for ensuring proper use of cards and mitigating this problem have become increasingly hi-tech, with the most powerful methods typically being data-driven. Data-driven methods for card controls and security can be made increasingly more powerful through improving the reliability and accuracy of data or expanding the amount of available data. Conversely, inaccurate or unreliable data can limit the potential power of the most advanced data-driven methods.

The available data often includes data associated with a transaction authorization message. A transaction authorization message is generated by a merchant and contains details about the transaction. As will be understood by one of skill in the art, the authorization message may be formatted according to the ISO-8583 standard, though it also will be understood that not all authorization messages conform to the ISO-8583 standard and may instead conform to other standards. The generated transaction authorization message may include a merchant name, merchant identifier, merchant category code (MCC), the country and state codes of the merchant's location, and a merchant business-listing address. However, the merchant information available within a transaction authorization message may be inaccurate or missing altogether for various reasons. As a result, transactions may be improperly authorized or denied.

Accordingly, a need exists for improved merchant data which may result in improved merchant transaction processing.

### SUMMARY

Aspects of the disclosed technology include systems and methods for improving merchant data. Consistent with the disclosed embodiments, the systems and methods may utilize one or more computing devices, processors, web servers, and databases. In some cases, certain systems and methods may include a processor receiving a merchant authorization message from a device. The merchant authorization message may include a merchant name and a merchant category code. The processor may extract the merchant name and the merchant category code from the merchant authorization message. The processor may identify and retrieve location data belonging to an entry within a first database that matches at least a portion of the merchant name. The processor may identify a first portion of the merchant name consistent with a system identification and a second portion of the merchant name consistent with a type of payment terminal. Responsive to identifying the first and second portion of the merchant name, the processor may remove the first and second portion from the merchant name such that an updated merchant name is provided. From a second database, the processor may retrieve a plurality of entries, each of the plurality of retrieved entries includes a name field containing name data matching at least a portion of the updated merchant name, a geography field containing geographic data representative of a geographic location within a predetermined distance of a physical location represented by the location data, and a merchant category field containing merchant category data. The processor may determine a relevance score for each of the plurality of retrieved entries based at least upon a combination of a distance between the geographic location for a particular retrieved entry and the physical location, and how closely the name data for the particular retrieved entry matches the updated merchant name. Based on the determined relevance scores, the processor may sort each of the plurality of retrieved entries. The processor may associate the updated merchant name with a particular entry of the plurality of entries having the highest relevance score. The processor may further generate a dataset that includes the updated merchant name and, from the particular entry of the plurality of entries having the highest relevance score, the geography field containing geographic data representative of the geographic location and the merchant category field containing the merchant category data. The processor may compare the merchant category data to a pre-defined list of merchant categories. Responsive to finding an inexact match, updating the merchant category data to be representative of one of the pre-defined list of merchant categories having the most similarity to the merchant category. The method further includes comparing the merchant category code to the merchant category data to determine a merchant category similarity score. Responsive to the merchant category data having a merchant category similarity score above a predetermined threshold, the processor updates the merchant category field to include data representative of the respective merchant category code. The processor may output, for transmission, the dataset to the device.

In some embodiments, the merchant authorization message further comprises at least one of a merchant identifier, a merchant location including at least one of a country code and a state code, and a merchant address. According to some embodiments, the identified location data may include geographic coordinates. The method may further include generating a merchant address based on the geographic coordinates and associating the merchant address with the physical location. In some embodiments, the method may include the processor updating the merchant category field to include a merchant category similarity score associated with each respective merchant category. The merchant category similarity score may be within a range of 0.0 and 1.0 where the merchant category similarity score of 1.0 represents an exact match and the merchant category similarity score of 0.0 represents no match.

According to some embodiments, the generated dataset may be transmitted to the second database, the third database, and/or the device. In some embodiments, each of the plurality of retrieved entries may further include a website field containing a merchant website address. The generated dataset may include the website field containing the merchant website address from the particular entry of the plurality of entries having the highest relevance score.

Another example embodiment may include a method for improved merchant data including generating an umbrella merchant name. The method may include a processor receiving a plurality of merchant authorization messages. Each of the plurality of merchant authorization messages includes at least a merchant name and a merchant category code. The processor may extract the respective merchant name and the respective merchant category code from each of the plurality of merchant authorization messages. The processor identifies, from each respective merchant name, a first portion of the merchant name consistent with a system identification and a second portion of the merchant name consistent with a type of payment terminal. In response, the processor removes, from the merchant name, the first portion of the merchant name consistent with a system identification and the second portion of the merchant name consistent with a type of payment terminal.

The method may further include retrieving a plurality of entries from a database. Each of the retrieved entries from the plurality of entries includes a name field containing name data matching at least a portion of the updated respective merchant name, a website address field containing website address data, and a merchant category field containing merchant category data. For each respective website address data, the processor identifies a first portion of the website address data consistent with a protocol, a second portion of the website address data consistent with a subdomain, and a third portion of the website address data consistent with a path. The processor removes, from each respective website address data, the first portion of the website address data consistent with a protocol, a second portion of the website address data consistent with a subdomain, and a third portion of the website address data consistent with a path.

The processor may group each of the retrieved plurality of entries based on the updated respective merchant name matching at least a portion of the name data and/or the updated respective merchant name matching at least a portion of the updated website address data. For each grouped plurality of entries, the processor generates an umbrella merchant name based on each of the updated respective merchant names of the grouped plurality of entries. The umbrella merchant name may be associated with each of the grouped plurality of entries. The processor may generate a dataset comprising the umbrella merchant name and each of the grouped plurality of entries. In some embodiments, the dataset is transmitted to a device.

In an example scenario, the merchant name present within the authorization message may contain data relating to multiple merchants at a given location. For example, some merchant name fields contain an address instead of a merchant name or may contain the name of a shopping center housing multiple merchants. In another scenario, an authorization message may contain a single merchant name for a plurality of merchants. This may occur, for example, when a large department store partners with another merchant to host a café within the department store. Transactions from both of these merchants may appear as originating from the same merchant (the department store). In both scenarios mentioned above, the merchant name field does not provide all of the information necessary to clarify the ambiguity. In these instances, the method may utilize other consistent fields within the authorization message to produce reliable results. These other fields may include the merchant category code, the transaction amount, the transaction time, the terminal ID, and/or the like.

In the scenarios provided above, the merchant category code may be used as an additional reference in the search with the database to improve search parameters. The merchant category code may be used to further filter results from the database by excluding all merchants with largely different categorizations. For example, for a pet store with an ambiguous merchant name, a search of the database may return a plurality of merchants located at the same location. However, re-running the search with the merchant category code data will exclude previously included merchants having merchant category codes such as a restaurant, a grocery store, or a clothing store. Consequently, the search produces less ambiguous results.

Similarly, the transaction amount or the transaction time may also enhance results in situations where a plurality of merchant names exist. The historical transaction behavior of the merchant may be used to understand which result is the more likely. For example, if the method is attempting to find information relating to a restaurant, but a search of a database returns two restaurants at the given location, the transaction patterns of the restaurant may be used to give additional context to the search. In this scenario, one of the restaurants returned in the results may be an expensive restaurant that is only open in the evenings, while the other may be a fast food restaurant open all day. By analyzing the transaction behaviors of the merchant, the method can determine the merchant has a low average transaction amount and the transactions occur over a long duration. Based on this information, the method may determine the merchant corresponds to the fast food restaurant.

The terminal ID may be used to identify various terminals within a merchant storefront belonging to different merchants. As mentioned above, in the example of a large department store partnered with a café within the department store, the transactions from both merchants may appear as originating from the same merchant (the department store). In this example, an algorithm may identify the terminal ID and determine the specific terminals corresponding to each merchant. Further, as a result of the method identifying one terminal having a lower average transaction amount, it determines the terminal belongs to the café because the café has lower value transactions on average than the department store. Used separately or in conjunction, these transaction parameters can give extra context to the method and disambiguate results. Further features of the present disclosure, and the advantages offered thereby, are explained in greater detail hereinafter with reference to specific embodiments illustrated in the accompanying drawings, wherein like elements are indicated by like reference designators.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1 is a diagram of an example environment that may be used to implement one or more embodiments of the present disclosure;

FIG. 2 is an example timing diagram for improving merchant data according to an example embodiment;

FIG. 3 is an example flow chart of a method for improving merchant data according to an example embodiment;

FIG. 4 is an example timing diagram for a particular method for improving merchant data according to an example embodiment;

FIG. 5 is an example flow chart of a particular method for improving merchant data according to an example embodiment; and

FIG. 6 is a block diagram of an example computer system that may implement certain aspects of the present disclosure.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified.

In an example scenario relevant to the disclosed systems and methods, Bob's Bar is located in a small college town. The merchant category code (“MCC”) associated with Bob's Bar is “5812,” which is representative of a restaurant. But as the name suggests, Bob's Bar primarily serves alcohol along with a limited food menu. A certain fleet or university card wants to prevent its cardholders from purchasing alcohol and may decline all transactions initiated by merchants with MCCs corresponding to “Bar” or “Liquor Store.” Because Bob's Bar is reported as a restaurant, cardholders may be able to misuse funds and improperly transact at the merchant. Aspects of the disclosed technology can collect Bob's Bar's merchant's category data from a third-party service (e.g., second database), which indicates that Bob's Bar is, in fact, a bar as opposed to a restaurant. The disclosed systems and methods could then compare the merchant category data against a list of existing merchant categories and determine that the merchant category data is an exact match with the “bar” category in the existing merchant categories. The disclosed systems and methods can then compare the merchant category data associated with Bob's (i.e., “bar”) against the MCC associated with Bob's Bar (i.e., “restaurant”) to generate a similarity score (e.g., a “merchant category code similarity”). In this case, because the merchant category data and the MCC do not match, the disclosed systems and methods may provide a merchant category code similarity score of, for example, 0.4. Because of the low score, the disclosed systems and methods could determine that the MCC for Bob's Bar should be “bar” as opposed to “restaurant” as it currently is categorized. As a result, going forward, Bob's Bar would be associated with the MCC corresponding to “bar.” Accordingly, any future transactions emanating from a fleet or university card will be properly declined.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

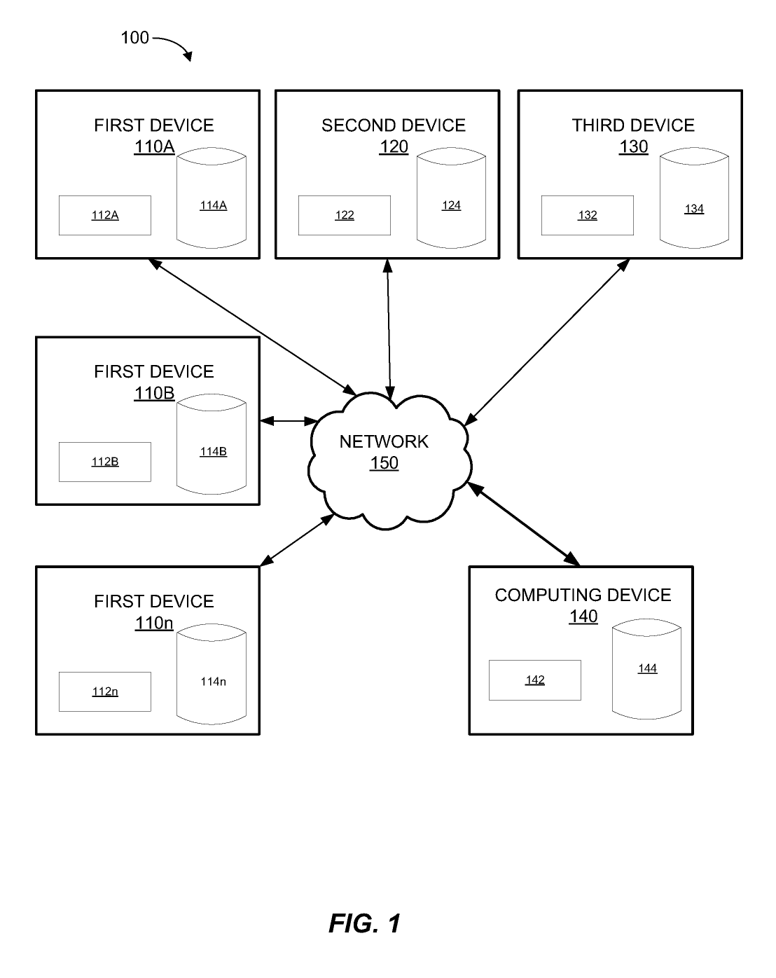

FIG. 1 shows an example environment 100 that may implement certain aspects of the present disclosure. The components and arrangements shown in FIG. 1 are not intended to limit the disclosed embodiments as the components used to implement the disclosed processes and features may vary. As shown in FIG. 1, in some implementations the environment 100 include a network 150, and one or more first devices 110A-100n, a second device 120, a third device 130 and computing device 140 which may include respective processors 112A-112n, 122, 132 and 142, and respective databases 114A-114n, 124, 134, and 144. As a non-limiting example, any first device 110 may be a device capable of processing a merchant transaction such as a point of sale device, a mobile device equipped with a card reader, or any other similarly configured device. The network 150 may include a network of interconnected computing devices more commonly referred to as the internet. The second device 120 and/or the third device 130 may be web servers.

In certain implementations according to the present disclosure, and as shown in FIG. 1, a first device (e.g., 110A) may include a processor (e.g., 112A), a database (e.g., 114A), and a user interface (e.g., 116A). A first device (e.g., 110A) may be configured to communicate with computing device 140. Accordingly, when a user (e.g., a customer) scans a card to conduct a transaction with the vendor associated with first device 110A, first device 110A can send a merchant authorization message to computing device 140. Computing device 140 may serve as an intermediary between a point of sale device (e.g., first device 110) and an issuer bank (i.e., a bank issuing the cardholder's card that is used in the attempted transaction). This merchant authorization message may be organized in a format according to certain standards. For example, the merchant authorization message can be organized according to the ISO-8583 standard or the ISO-20022 standard. The merchant authorization message may include a merchant name, a merchant identifier, a merchant category code (MCC), a country and/or state codes of the merchant's location, the merchant business-listing address, and/or the like. In addition to outputting the merchant authorization message, first device 110A may store data representative of the merchant authorization message in database 114. Additionally, database 114 may store other related transaction data. First device 110A may have an associated payment terminal identification, which may be included as part of the merchant name field within the merchant authorization message. In addition to transmitting information to computing device 140, first device 110A also may receive information from computing device 140. This received information may include, for example, a dataset comprising an updated merchant authorization message, as will be discussed herein, which first device 110A may in turn use in processing the customer's transaction. Further, the first device 110A may save data representative of the dataset in database 114 for future use. Finally, user interface 116A may provide a display that can indicate information to the customer or the vendor, which can indicate, for example, the status of the transaction and/or various visual displays of user inputs and outputs by the first device 110.

Computing device 140, in certain implementations of the present disclosure, and as shown in FIG. 1, includes a processor 142 and a database 144. Processor 142 may receive a merchant authorization message from first device 110. Processor 142 may extract, from this authorization message, a merchant name, a merchant identifier, a merchant category code (MCC), the country and state codes of the merchant's location, the merchant business-listing address, and/or the like. Further, processor 142 may identify, from this merchant name, a portion consistent with a system identification and/or a portion consistent with a type of payment terminal. The payment terminal type may be indicative of the type of payment terminal processing the transaction. For example, a payment terminal (e.g., first device 110) issued by the company Square® may have a code of “SQ” appended to the merchant name. The system identification may be a string of numbers longer than three digits long, assigned to each system. Processor 142 may remove the system identification and/or the payment terminal type from the merchant name such that an updated merchant name is provided.

Database 124 may include a plurality of entries having at least a name field for name data and a location field for location data. Processor 142 may access database 124 to identify location data belonging to an entry having name data in a name field matching at least a portion of the merchant name. This location data may include crowd-sourced location data. Further, this location data may include geographic coordinates and/or an inferred location type. For example, an inferred location type may be identified for each merchant name based on learned and/or identified geographic coordinates of the merchant location(s) and the location type of the merchant (e.g., single-location, multi-location, or mobile-location). For example, the inferred location type may be identified as described in U.S. patent application Ser. No. 16/107,348, filed on Aug. 21, 2018, entitled “Systems and Methods for Providing Low-Latency Access to Cardholder Location Data and Determining Merchant Locations and Types,” the contents of which are expressly incorporated herein in its entirety. Processor 142 may retrieve the identified location data from second device 120. Retrieving the identified location data may include processor 122 transmitting location data belonging to the identified entry to processor 142. In some embodiments, to retrieve the identified location data from database 124, processor 142 may request access to database 124 and receive approval from second device 120.

Database 134 may include a plurality of entries. Each of the plurality of entries may include a name field, a geography field, a merchant category field, a merchant identifier field, a merchant business-listing address field, a website field containing a merchant website address, and/or the like. The plurality of entries within database 134 may be representative of third-party merchant data. Processor 142 may retrieve a plurality of entries from database 134 associated with the third device 130. Similar to retrieving data from second device 120, retrieving data from third device 130 may require requesting access to database 134 and receiving approval from third device 130. Processor 142 may output, for transmission, a query based on the updated merchant name and location data from the identified entry retrieved from database 124. In response, processor 142 may receive from third device 130 (processor 132) a plurality of entries belonging to database 134 having name data in a name field matching at least a portion of the updated merchant name and having a geography field containing geographic data representative of a geographic location within a certain distance of a physical location represented by the location data. The amount of distance between the geographic location and the physical location indicative of a match may be predetermined.

For each of the plurality of retrieved entries, processor 142 may determine a relevance score. The relevance score can represent how closely the name data for the particular retrieved entry matches the updated merchant name, and whether the distance between the geographic location for a particular retrieved entry and the physical location is determined to be near. A distance may be predetermined as “near” or “far” based on a certain number of miles. In some embodiments, the distance may be relative based on historic distance data for a particular merchant and/or a group of merchants. For example, a distance of five miles may be considered far based on previous distance data for a particular merchant, but for another merchant, a distance of five miles may be considered near because of previous distance data. As will be appreciated, a high relevance score can be indicative of a close match of the compared data. The comparison of the name data and the updated merchant name may have a lesser, greater, or equal weight to the comparison of the distance between the geographic location for a particular retrieved entry and the physical location. Processor 142 can sort each of the plurality of entries in order of the determined relevance scores. The determined relevance scores may be in ascending order or descending order. Processor 142 also can associate the particular entry having the highest relevance score with the updated merchant name.

Subsequently, processor 142 can generate a dataset that includes the updated merchant name and, from the particular entry of the plurality of entries having the highest relevance score, the geography field containing geographic data representative of the geographic location and the merchant category field containing the merchant category data. In some embodiments, the dataset generated by processor 142 may also include a merchant identifier field, a merchant business-listing address field, a website field containing a merchant website address, and/or the like. Next, processor 142 can compare the merchant category data to a pre-defined list of merchant categories. When the merchant category data does not match any of the entries from the pre-defined list, the merchant category data is updated to include data representative of the entry of the pre-defined list having the most similarity to the merchant category data. For example, if the merchant category data includes the term “Pubs,” and the pre-defined list includes the terms “Bars” and “Restaurants”, “Bars” will be the closest match because it is synonymous with an establishment primarily serving alcohol. Next, processor 142 can compare the merchant category data to the merchant category code to determine a merchant category similarity score. The merchant category similarity score may range from a score of 0.0 to 1.0. In some embodiments, a score of 1.0 represents an exact match while a score of 0.0 represents no match. Processor 142 may update the merchant category field of the dataset to further include the similarity score. When the similarity score is beyond a predetermined threshold, processor 142 may update merchant category field to include data representative of the respective merchant category. Processor 142 may output, for transmission, the dataset to first device 110 and/or third device 130 (database 134). In some embodiments, processor 142 may store the generated dataset within database 144.

In another example embodiment, one or more first devices 110 may transmit a plurality of merchant authorization messages to processor 142. Each of the plurality of merchant authorization messages includes a merchant name and/or a merchant category code. Processor 142 extracts the respective merchant name and the respective merchant category code from each of the plurality of merchant authorization messages. Processor 142 may identify, from each respective merchant name, a first portion of the merchant name consistent with a system identification and a second portion of the merchant name consistent with a type of payment terminal. Further, processor 142 may remove, from each respective merchant name, the first portion of the merchant name consistent with a system identification and the second portion of the merchant name consistent with a type of payment terminal.

Processor 142 may retrieve from database 134 a plurality of entries having a name field containing name data matching at least a portion of the updated respective merchant name, a website address field containing website address data, and/or a merchant category field containing merchant category data. As mentioned above, retrieving a plurality of entries from database 134 may include requesting access to database 134 and receiving approval from database 134. From each respective website address data, processor 142 may identify a first portion of the website address data consistent with a protocol, a second portion of the website address data consistent with a subdomain, and/or a third portion of the website address data consistent with a path. For example, in the web address http://sample.example.com/number, “http” represents a protocol, “sample” represents a subdomain, and “/number” represents a path. Processor 142 may remove, from each respective website address data, the first portion of the website address data consistent with a protocol, the second portion of the website address data consistent with a subdomain, and/or the third portion of the website address data consistent with a path, to provide a respective updated website address data.

Each of the retrieved plurality of entries may be grouped by the processor 142 based on the updated respective merchant name matching at least a portion of the name data and/or the updated respective merchant name matching at least a portion of the updated website address data. Processor 142 generates an umbrella merchant name to represent each of the grouped plurality of entries. The umbrella merchant name may be based on common aspects of each of the updated respective merchant names of the grouped plurality of entries. For example, an umbrella merchant name of “Cost Store” may be assigned to a group of entries having “Cost” as part of each respective merchant name. Processor 142 may associate the umbrella merchant name with each of the grouped plurality of entries. Further, processor 142 may generate a dataset including the umbrella merchant name and each of the grouped plurality of entries. In some embodiments, processor 142 may output, for transmission, the dataset to first device 110.

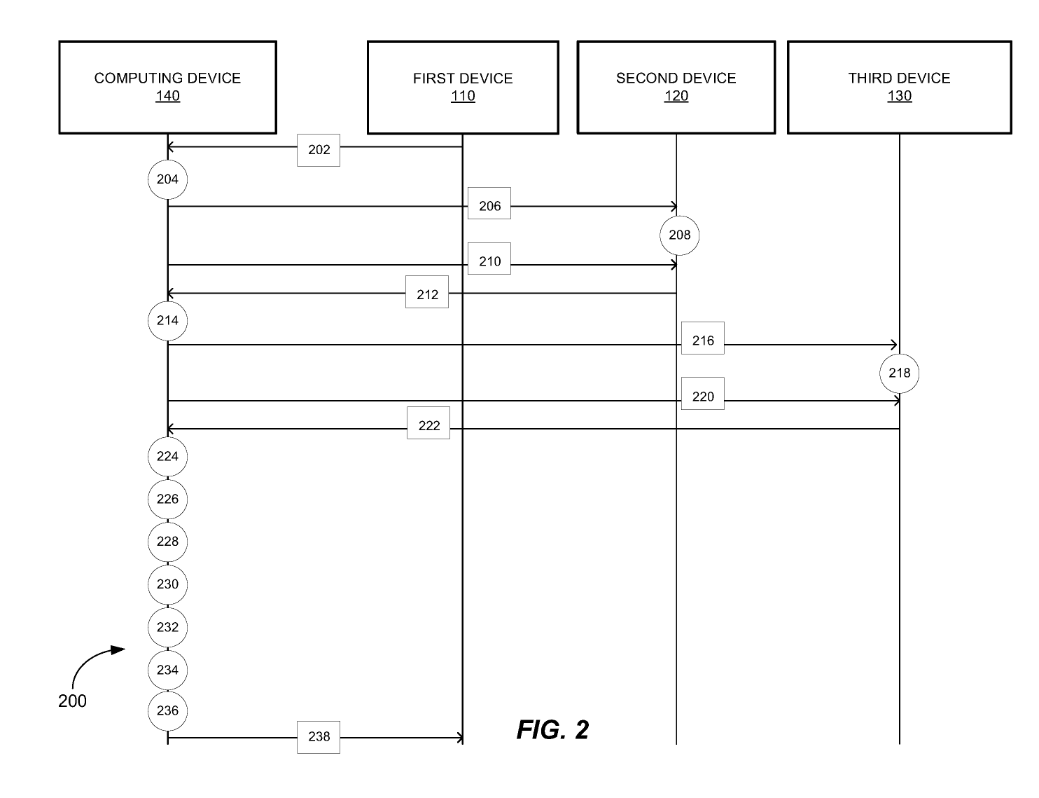

FIG. 2 illustrates an example timing diagram for improving merchant data. According to some embodiments, first device 110 transmits 202 a merchant authorization message to computing device 140. First device 110 may transmit the merchant authorization in the course of processing a transaction with a consumer. The merchant authorization message may include a merchant name, a merchant category code, a merchant identifier, a merchant location including at least one of a country code and a state code, and/or a merchant address. Computing device 140 extracts 204 the merchant name and the merchant category code from the merchant authorization message. Then computing device 140 requests 206 access to database 124 and second device 120 grants 208 permission to computing device 120 to access database 124. To receive access, computing device 140 may submit, to second device 120, credentials (e.g., username/password combination, biometric data, an internet protocol address, device address, and/or the like) for verification.

As further shown, computing device 140 transmits 210 a request to second device 120 for location data based on the merchant name. The location data may reside within an entry of database 124 having at least a portion of a match in the name field to the merchant name. Second device 120 may then transmit 212 the location data associated with the matching entry to computing device 140. As shown, processor 142 then updates 214 the merchant name. Updating the merchant name may include processor 142 identifying and removing a system identification portion and a payment terminal type portion from the merchant name. Then computing device 140 can request 216 access to database 134 of third device 130. Similar to 206 and 208 above, to gain access to database 134, computing device 140 may transmit user credentials for verification to third device 130. Third device 130 can then grant 218 access to database 134 to computing device 140.

As further shown in FIG. 2, computing device 140 transmits 220 a request, to third device 130, for a plurality of entries within database 134 matching the updated merchant name and the location data. Each of the plurality of entries may include a name field, a geography field, a merchant category field, a merchant identifier field, a merchant business-listing address field, a website field containing a merchant website address, and/or the like. The request may include the updated merchant name and the location data. Matching the updated merchant name may include a name field of each of the plurality of entries containing name data matching at least a portion of the updated merchant name. Similarly, matching the location data may include a geography field containing geographic data representative of a geographic location within a predetermined distance of a physical location represented by the location data. Then third device 130 can transmit 222, to computing device 140, the plurality of entries matching the updated merchant name and location data, and computing device 140 can determine 224 a relevance score for each of the plurality of entries. The relevance score can be based on a combination of how closely the name data how closely the name data for a particular retrieved entry matches the updated merchant name, and a distance between the geographic location for a particular retrieved entry and the physical location. The higher the relevance score, the closer the combination of the compared name data and geographic location matches the updated merchant name and the physical location, respectively.

Computing device 140 can then sort 226 each of the plurality of entries by relevance score in either ascending order or descending order and associate 228 the updated merchant name with the entry from the plurality of entries having the highest relevance score. As further show, computing device 140 can generate 230 a dataset including the updated merchant name and, from the particular entry of the plurality of entries having the highest relevance score, the geography field containing geographic data representative of the geographic location and the merchant category field containing the merchant category data. In some embodiments, the dataset may further include a merchant identifier field having a merchant identifier, a merchant business-listing address field having a merchant address, a website field containing a merchant website address, and/or the like. Computing device 140 also can compare 232 the merchant category data to a pre-defined list of merchant categories. As non-limiting examples, the pre-defined list of merchant categories may include the following, “bar,” “restaurant,” “department store,” and “convenience store.” If the merchant category data is not an exact match of an entry of the pre-defined list of merchant categories, the computing device 140 determines the merchant category based on the entry from the pre-defined list having the most similarity to the merchant category data. Subsequent to determining the entry of the pre-defined list having the most similarity to the merchant category data, computing device 140 updates the merchant category data to be representative of the entry of the pre-defined list having the most similarity to the merchant category data.

As can further be seen in FIG. 2, computing device 140 can then determine 234 the merchant category similarity score by comparing the merchant category data to the merchant category code. The merchant category similarity score may be within a range of 0.0 to 1.0, with 1.0 representing an exact match and 0.0 representing no match. If the merchant category similarity score is above a predetermined threshold, computing device 140 can update 236 the merchant category field to include data representative of the respective merchant category field and then output 238, for transmission, the dataset to first device 110. First device 110 may use the dataset for enhanced merchant transaction processing. In some embodiments, computing device may output, for transmission, the dataset to second device 120 and/or third device 130. According to some embodiments, computing device 140 may store the dataset within database 144.

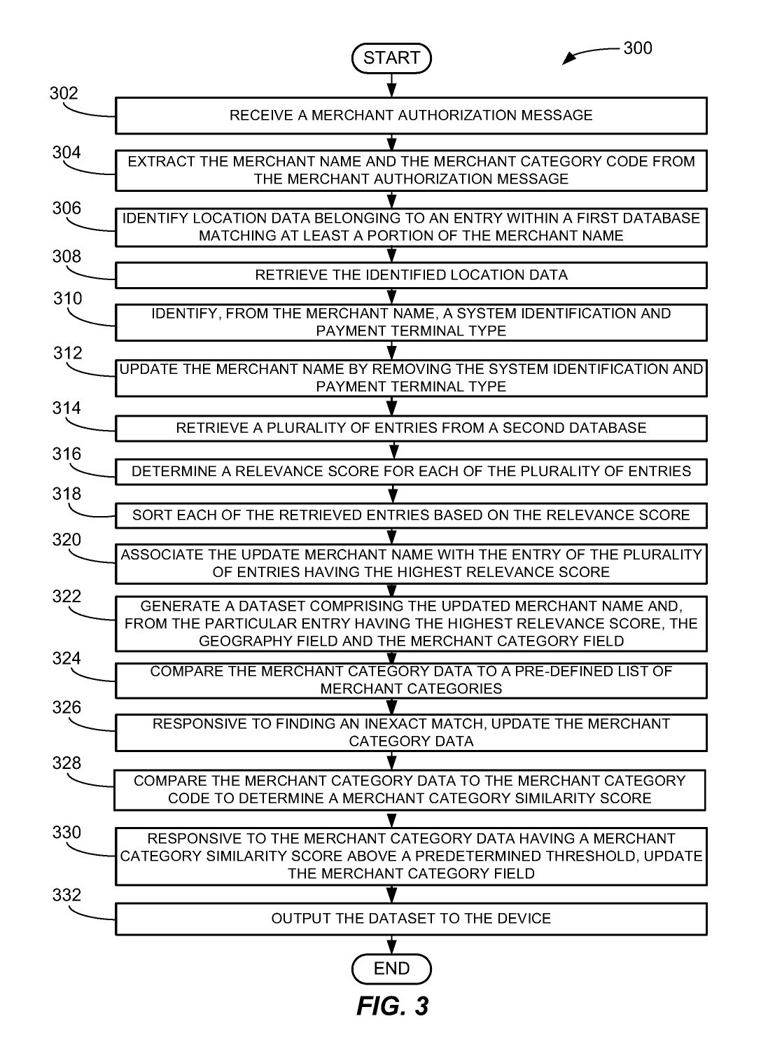

FIG. 3 is an example flow chart of a method 300 for improving merchant data. As shown, method 300 can include receiving 302, from first device 110, a merchant authorization message. The merchant authorization message includes a merchant name and a merchant category code. In some embodiments, the merchant authorization message may further include a merchant identifier, a merchant location including at least one of a country code and a state code, a merchant address, and/or the like. Further, method 300 can include extracting 304 the merchant name and the merchant category code from the merchant authorization message and then identifying 306 location data belonging to an entry within a first database (e.g., database 124) based on the merchant name matching at least a portion of data within the name field of the entry. Identifying the location data may include a query from processor 142 to database 124. As further shown, method 300 can include retrieving 308 the identified location data from a first database (e.g., database 124). In some embodiments, the identified location data may include geographic coordinates which processor 142 may use to generate a merchant address. Further, the merchant address may be associated with the physical location. Method 300 also can include identifying 310 a portion of the merchant name indicative of a system identification and a portion indicative of a payment terminal type and then removing 312 the identified system identification portion and the identified payment terminal type portion from the merchant name at 312. As shown, method 300 can then include retrieving 314 a plurality of entries from a second database (e.g., database 134). Retrieving the retrieved plurality of entries are entries from a second database may involve processor 142 submitting a query request to database 134 for one or more entries having a name field containing name data matching at least a portion of the updated merchant name, and a geography field containing geographic data representative of a geographic location within a predetermined distance of a physical location represented by the location data. In addition to name data and geographic data, each of the plurality of retrieved entries may have a merchant category field containing merchant category data.

As further shown in FIG. 3, method 300 can include determining 316 a relevance score for each of the plurality of retrieved entries. As discussed, the relevance score can be a numerical representation of the distance between the geographic location for a particular retrieved entry and the physical location, and how closely the name data for the particular retrieved entry matches the updated merchant name. Additionally, method 300 can include sorting 318 the plurality of entries based on the relevance score in either ascending order or descending order and associated 320 the entry having the highest relevance score with the updated merchant name. Next, method 300 can include generating 322 a dataset including the updated merchant name and, from the particular entry having the highest relevance score, a geography field containing geographic data representative of a geographic location and merchant category field containing merchant category data. Furthermore, method 300 can include comparing 324 the merchant category data to each entry of a list of pre-defined merchant categories. Responsive to not finding an exact match, method 300 can include updating 326 the merchant category data to be representative of the entry of the pre-defined list of merchant categories having the most similarity to the merchant category data. In some embodiments, not finding an exact match occurs when each character of a character sequence of the merchant category data does not match each character of character sequence of each entry of a pre-defined list of merchant categories.

As shown, method 300 can then include comparing 328 the merchant category data to the merchant category code to determine a merchant category similarity score. As discussed, the merchant category similarity score may be within a range of 1.0 and 0.0 with a score of 1.0 representing an exact match and a score of 0.0 representing no match. Responsive to the merchant category data having a merchant category similarity score above a predetermined threshold, method 300 can include updating 330 the merchant category field to be representative of the respective merchant category code. Accordingly, when a high merchant category similarity score exists between the merchant category data and the merchant category code, processor 142 determines the original merchant category code to be proper. Finally, method 300 can include outputting 332, for transmission, the dataset to the first device 110. In some embodiments, the dataset includes a merchant category similarity score field containing data representative of the merchant category similarity score.

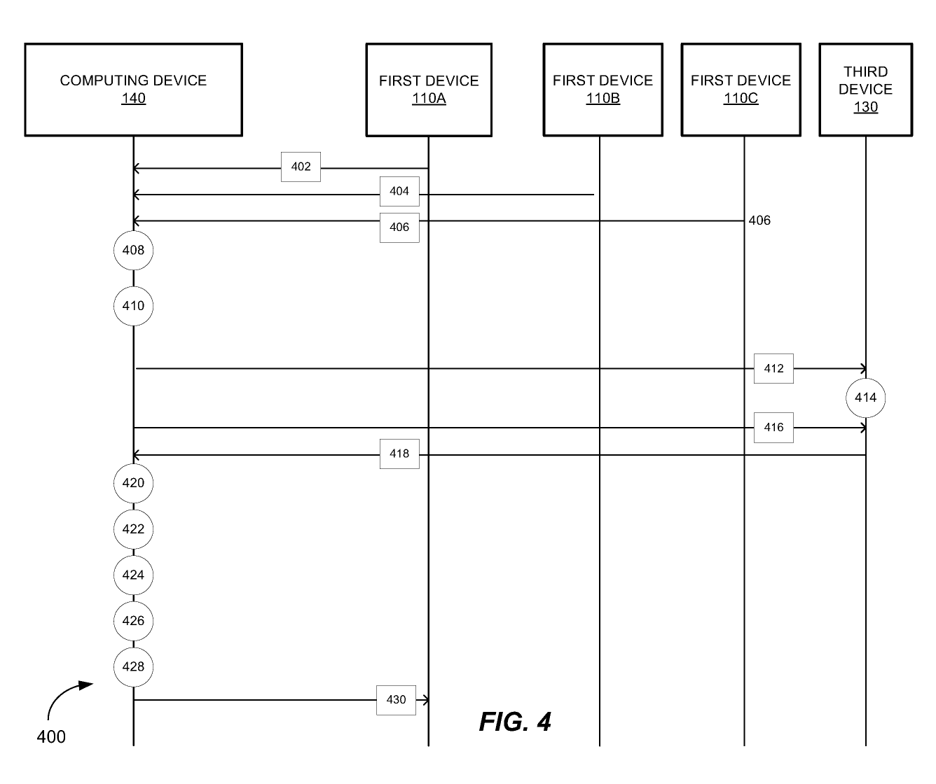

FIG. 4 is an example timing diagram 400 for a particular method for improving merchant data. According to some embodiments, computing device 140 receives a plurality of merchant authorization messages. Computing device 140 may receive the plurality of merchant authorization messages from one or more first devices 110A-100n. Each first device 110 may transmit one or more merchant authorization messages to computing device 140. Further, the plurality of merchant authorization messages may be transmitted concurrently or separately over a period of time. As shown, first device 110A can transmit 402 a merchant authorization message to computing device 140. Similarly, first device 110B and first device 110C each transmit (404, 406) a merchant authorization message to computing device 140. Each of the plurality of merchant transaction authorization messages may include a merchant name, a merchant category code, and/or the like. Computing device 140 can then extract 408 the merchant name and merchant category code from each of the plurality of merchant authorization messages and update 410 each of the plurality of merchant authorization messages to provide a plurality of updated merchant names. Updating the plurality of merchant authorization messages can include processor 142 identifying, from each respective merchant name, a first portion of the merchant name consistent with a system identification and a second portion of the merchant name consistent with a type of payment terminal. Updating the plurality of merchant authorization messages also can include processor 142 removing, from each respective merchant name, the first portion of the merchant name consistent with a system identification and the second portion of the merchant name consistent with a type of payment terminal. Computing device 140 can retrieve a plurality of entries from database 134. Retrieving the plurality of entries may include computing device 140 requesting 412 access to database 134. In response, third device 130 can grant 414 permission to computing device 140 to access database 134 and, for each updated merchant name, computing device 140 transmits 416 a request, to third device 130, for a plurality of entries matching at least a portion of the respective updated merchant name. Then as shown, third device 130 can transmit 418, to computing device 140, a plurality of entries for each respective updated merchant name. Each of the plurality of entries include a name field containing name data matching at least a portion of the updated respective merchant name, a website address field containing website address data, and/or a merchant category field containing merchant category data.

As further shown, for each of the plurality of entries, computing device 140 can update 420 the respective website address data. Updating the website address data can include identifying and removing each portion of the website address data until only the top-level domain and the domain name remain. For a website address such as “http://www.sample.example.com/path2”, only “example.com” would remain after an update. Therefore, updating the website address data may include computing device 140 identifying and removing, from the website address data, a protocol, a subdomain, a path, and/or any portion of the website address data not representative of the top-level domain or the domain name. Computing device 140 can then group 422 each of the plurality of retrieved entries based on the updated respective merchant name matching at least a portion of the name data and/or the updated respective merchant name matching at least a portion of the updated website address data. Then, for each grouped plurality of entries, computing device 140 can generate 424 an umbrella merchant name based on each of the respective updated merchant names of the grouped plurality of entries. An umbrella merchant name may be based on common aspects of each of the respective updated merchant names. For example, for the following merchant names, “TargetNY,” “Target Cali,” and “TargetNJ”, an umbrella merchant name of “Target” may be generated.

Computing device 140 may further associate 426 the respective umbrella merchant name with each of the grouped plurality of entries and then generate 428 a dataset that includes the respective umbrella merchant name and each of the grouped plurality of entries. At 430, computing device 140 transmits the dataset to the first device 110A. Finally, in some embodiments, computing device 140 may output 432, for transmission, the dataset to second device 120 and/or third device 130. According to some embodiments, computing device 140 may store the dataset within database 144.

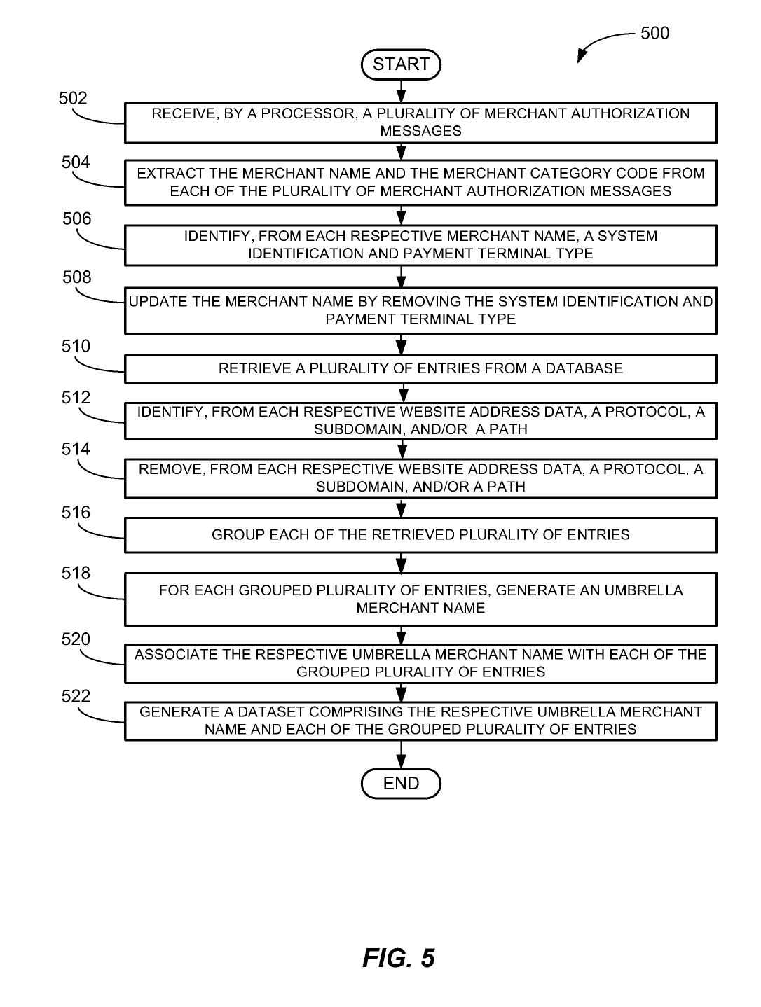

FIG. 5 is an example flow chart of a particular method 500 for improving merchant data. As shown, method 500 can include receiving 502 a plurality of merchant authorization messages. One or more first devices 110A110n may transmit the plurality of merchant authorization messages to processor 142. Further, method 500 can include extracting 504 the merchant name and the merchant category code from each of the plurality of merchant authorization messages and then identifying 506, from each respective merchant name, a first portion of the merchant name consistent with a system identification and a second portion of the merchant name consistent with a type of payment terminal. As further shown, method 500 can include updating 508 the merchant name by removing, from the merchant name, the first portion of the merchant name consistent with a system identification and the second portion of the merchant name consistent with a type of payment terminal. For each respective updated merchant name, method 500 can include retrieving 510 a plurality of entries from database 134. Processor 142 can retrieve the plurality of entries based on a name field of each entry containing name data matching at least a portion of the respective updated merchant name. The plurality of entries may further include a website address field containing website address data and/or a merchant category field containing merchant category data. As further shown, method 500 can include identifying 512, from each respective website address data, a protocol, a subdomain, and/or a path. In some embodiments, the processor 142 may further identify other portions of the website address data. Method 500 can include removing 514, from each respective website address data, the protocol, the subdomain, the path, and/or any portion not representative of the top-level domain or the subdomain and then grouping 516 each of the retrieved plurality of entries based on the updated respective merchant name matching at least a portion of the name data and/or the updated respective merchant name matching at least a portion of the updated website address data. As further shown, method 500 includes generating 518 a respective umbrella merchant name for each grouped plurality of entries. Then, as shown, method 500 can include associating 520 the respective umbrella merchant name with each of the grouped plurality of entries and generating 522 a dataset including the respective umbrella merchant and each of the grouped plurality of entries. Therefore, the dataset may include a respective umbrella merchant name, a name field containing name data, a website address field containing website address data, and/or a merchant category field containing merchant category data. In certain embodiments, processor 142 may transmit the dataset to one or more first devices 110An, second device 120, and/or third device 130. First devices 110An may use the dataset for enhanced merchant transaction processing. Second device 120 and/or third device 130 may store the dataset within database 124 and/or database 134, respectively.

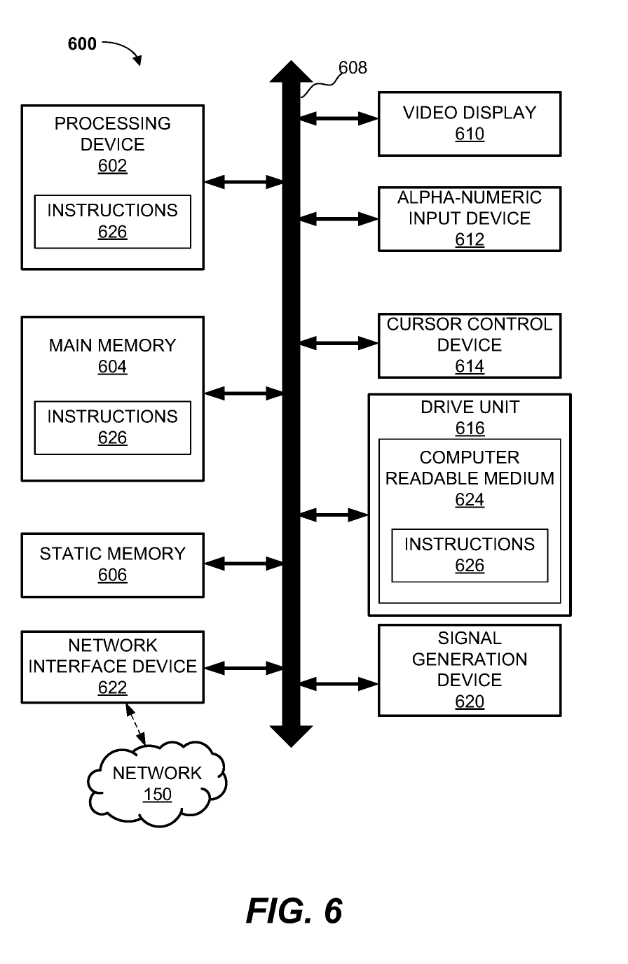

FIG. 6 is a block diagram of an example computer system 600 that may implement certain aspects of the present disclosure. The computer system 600 may include a set of instructions 626 for controlling operation of the computer system 600. In some implementations, the computer system 600 may be connected (e.g., networked) to other machines in a Local Area Network (LAN), an intranet, an extranet, a satellite communications system, or the Internet. The computer system 600 may operate in the capacity of a server or a client machine in a client-server network environment, or as a peer machine in a peer-to-peer (or distributed) network environment. The computer system 600 may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while a single computer system 600 is illustrated, the term “machine” shall also be taken to include any collection of machines (e.g., computers) that individually or jointly execute a set (or multiple sets) of instructions to perform any one or more of the methodologies discussed herein.

The computer system 600 includes a processing device 602, a main memory 604 (e.g., read-only memory (ROM), flash memory, dynamic random-access memory (DRAM) such as synchronous DRAM (SDRAM), etc.), a static memory 606 (e.g., flash memory, static random-access memory (SRAM), etc.), and a secondary memory 616 (e.g., a data storage device), which communicate with each other via a bus 608.

The processing device 602 represents one or more general-purpose processing devices such as a microprocessor, a microcontroller, a central processing unit, or the like. As non-limiting examples, the processing device 602 may be a reduced instruction set computing (RISC) microcontroller, a complex instruction set computing (CISC) microprocessor, a RISC microprocessor, very long instruction word (VLIW) microprocessor, a processor implementing other instruction sets, or one or more processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute the operations for electronically creating and trading derivative products based on one or more indices relating to volatility.

The computer system 600 may further include a network interface device 622, which is connectable to a network 150. The computer system 600 also may include a video display unit 610, i.e., a display (e.g., a liquid crystal display (LCD), a touch screen, or a cathode ray tube (CRT)), an alphanumeric input device 612 (e.g., a keyboard), a cursor control device 614 (e.g., a mouse), and a signal generation device 620 (e.g., a speaker).

The secondary memory 616 may include a non-transitory storage medium 624 on which is stored one or more sets of instructions 626 for the computer system 600 representing any one or more of the methodologies or functions described herein. For example, the instructions 626 may include instructions for implementing an asset tracking device including a power source and power management system or subsystem for a container or a trailer. The instructions 626 for the computer system 600 may also reside, completely or at least partially, within the main memory 604 and/or within the processing device 602 during execution thereof by the computer system 600, the main memory 604 and the processing device 602 also constituting computer-readable storage media.

While the storage medium 624 is shown in an example to be a single medium, the term “storage medium” should be taken to include a single medium or multiple media that store the one or more sets of instructions for a processing device. The term “storage medium” shall also be taken to include any medium that is capable of storing or encoding a set of instructions for execution by the machine that cause the machine to perform any one or more of the methodologies of the disclosure. The term “storage medium” shall accordingly be taken to include, but not be limited to, solid-state memories, and optical and magnetic media.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for improved merchant data, the method comprising:
receiving, by a processor and from a device, a merchant authorization message, the merchant authorization message comprising (i) a merchant name and (ii) a merchant category code;
extracting, by the processor and from the merchant authorization message, the merchant name and the merchant category code;
responsive to identifying, by the processor, location data belonging to an entry within a first database, wherein at least a portion of the entry matches at least a portion of the merchant name, retrieving the identified location data;
responsive to identifying, by the processor and from the merchant name, (i) a first portion of the merchant name consistent with a system identification and (ii) a second portion of the merchant name consistent with a type of payment terminal, removing, from the merchant name, (i) the first portion of the merchant name consistent with the system identification and (ii) the second portion of the merchant name consistent with the type of payment terminal to provide an updated merchant name;
retrieving, from a second database, a plurality of entries, each of the plurality of retrieved entries comprising (i) a name field containing name data matching at least a portion of the updated merchant name, (ii) a geography field containing geographic data representative of a geographic location within a predetermined distance of a physical location represented by the location data and (iii) a merchant category field containing merchant category data;
determining, for each of the plurality of retrieved entries, a relevance score based at least upon a combination of (i) a distance between the geographic location for a particular retrieved entry and the physical location and (ii) how closely the name data for the particular retrieved entry matches the updated merchant name;
sorting, based on the determined relevance scores, each of the plurality of retrieved entries;
associating, with the updated merchant name, a particular entry of the plurality of entries having the highest relevance score;
generating a dataset comprising (i) the updated merchant name and, from the particular entry of the plurality of entries having the highest relevance score, (ii) the geography field containing geographic data representative of the geographic location and (iii) the merchant category field containing the merchant category data;
comparing the merchant category data to a pre-defined list of merchant categories;
responsive to finding an inexact match, updating the merchant category data to be representative of one of the pre-defined list of merchant categories, wherein the one of the pre-defined list of merchant categories has the most similarity to the merchant category data;
comparing the merchant category data to the merchant category code to determine a merchant category similarity score;
responsive to the merchant category data having a merchant category similarity score above a predetermined threshold, updating the merchant category field to include data representative of the respective merchant category; and
outputting, for transmission, the dataset to the device.

2. The method of claim 1, wherein the merchant authorization message further comprises (iii) at least one of a merchant identifier, a merchant location comprising at least one of a country code and a state code, and a merchant address.

3. The method of claim 1, wherein the identified location data comprises geographic coordinates.

4. The method of claim 1, wherein each of the plurality of retrieved entries further comprises (iv) a website field containing a merchant website address.

5. The method of claim 1, wherein the dataset further comprises (iv) the website field containing the merchant website address.

6. The method of claim 1 further comprising updating the merchant category field to include a merchant category similarity score associated with each respective merchant category.

7. The method of claim 1 further comprising outputting, for transmission, the dataset to the second database.

8. The method of claim 1 further comprising storing the generated dataset in a third database associated with the processor.

9. The method of claim 1, wherein the merchant category similarity score is within a range of 0.0 and 1.0, and wherein the merchant category similarity score of 1.0 represents an exact match and wherein the merchant category similarity score of 0.0 represents no match.

10. The method of claim 3 further comprising:
generating, based on the geographic coordinates, a merchant address; and
associating the merchant address with the physical location.

11. A system for improving merchant data comprising:
one or more processor; and
at least one memory in communication with the one or more processors and storing computer program code that, when executed by the one or more processors, is configured to cause the system to:
receive, from a device, a merchant authorization message, the merchant authorization message comprising (i) a merchant name and (ii) a merchant category code;
extract, from the merchant authorization message, the first merchant name and the merchant category code;
in response to identifying location data belonging to an entry within a first database, wherein at least a portion of the entry matches at least a portion of the first merchant name, retrieve the identified location data;
in response to identifying from the first merchant name, (i) a first portion of the first merchant name consistent with a system identification and (ii) a second portion of the first merchant name consistent with a type of payment terminal, remove, from the first merchant name, (i) the first portion of the first merchant name consistent with the system identification and (ii) the second portion of the first merchant name consistent with the type of payment terminal to provide an updated merchant name;
retrieve, from a second database, a plurality of entries, each of the plurality of retrieved entries comprising (i) a name field containing name data matching at least a portion of the updated merchant name, (ii) a geography field containing geographic data representative of a geographic location within a predetermined distance of a physical location represented by the location data and (iii) a merchant category field containing merchant category data;
determine, for each of the plurality of retrieved entries, a relevance score based at least upon a combination of (i) a distance between the geographic location for a particular retrieved entry and the physical location and (ii) how closely the name data for the particular retrieved entry matches the updated merchant name;
sort, based on the determined relevance scores, each of the plurality of retrieved entries;
associate, with the updated merchant name, a particular entry of the plurality of entries having the highest relevance score;
generate a dataset comprising (i) the updated merchant name and, from the particular entry of the plurality of entries having the highest relevance score, (ii) the geography field containing geographic data representative of the geographic location and (iii) the merchant category field containing the merchant category data;
compare the merchant category data to a pre-defined list of merchant categories;
in response to finding an inexact match, update the merchant category data to be representative of one of the pre-defined list of merchant categories, wherein the one of the pre-defined list of merchant categories has the most similarity to the merchant category data;
comparing the merchant category data to the merchant category code to determine a merchant category similarity score;
in response to the merchant category data having a merchant category similarity score above a predetermined threshold, update the merchant category field to include data representative of the respective merchant category code; and
output, for transmission, the dataset to the device.

12. The system of claim 11, wherein the merchant authorization message further comprises (iii) at least one of a merchant identifier, a merchant location comprising at least one of a country code and a state code, and a merchant address.

13. The system of claim 11, wherein the identified location data comprises geographic coordinates.

14. The system of claim 11, wherein each of the plurality of retrieved entries further comprises (iv) a website field containing a merchant website address.

15. The system of claim 11, wherein the dataset further comprises (iv) the website field containing the merchant website address.

16. The system of claim 11 further comprising updating the merchant category field to include a merchant category similarity score associated with each respective merchant category.

17. The system of claim 11, wherein the merchant category similarity score is within a range of 0.0 and 1.0, and wherein the merchant category similarity score of 1.0 represents an exact match and wherein the merchant category similarity score of 0.0 represents no match.

18. The system of claim 13 further comprising:
generating, based on the geographic coordinates, a merchant address; and
associated the merchant address with the physical location.

19. A method for improving merchant data, the method comprising:
receiving, by a processor, a plurality of merchant authorization messages, each of the plurality of merchant authorization messages comprising (i) a merchant name and (ii) a merchant category code;
extracting, by the processor and from each of the plurality of merchant authorization messages, the respective merchant name and the respective merchant category code;
responsive to identifying, by the processor and from each respective merchant name, (i) a first portion of the merchant name consistent with a system identification and (ii) a second portion of the merchant name consistent with a type of payment terminal, removing, from the merchant name, (i) the first portion of the merchant name consistent with the system identification and (ii) the second portion of the merchant name consistent with the type of payment terminal to provide an respective updated merchant name;
for each updated respective merchant name, retrieving, from a database, a plurality of entries, each of the plurality of retrieved entries comprising (i) a name field containing name data matching at least a portion of the respective updated merchant name, (ii) a website address field containing website address data, and (iii) a merchant category field containing merchant category data;
responsive to identifying, by the processor and from each respective website address data, a first portion of the website address data consistent with a protocol, removing, from the website address data, the first portion of the website address data consistent with the protocol to provide a respective updated web site address data;
responsive to identifying, by the processor and from each respective website address data, a second portion of the website address data consistent with a subdomain, removing, from the website address data, the second portion of the website address data consistent with the subdomain to provide a respective updated website address data;
responsive to identifying, by the processor and from each respective website address data, a third portion of the website address data consistent with a path, removing, from the website address data, the third portion of the website address data consistent with the path to provide a respective updated website address data;
grouping, each of the retrieved plurality of entries based on at least one of (i) the respective updated merchant name matching at least a portion of the name data and (ii) the respective updated merchant name matching at least a portion of the updated website address data;
for each grouped plurality of entries, generating an umbrella merchant name based on each of the respective updated merchant names of the grouped plurality of entries;
associating the respective umbrella merchant name with each of the grouped plurality of entries; and
generating a dataset comprising the umbrella merchant name and each of the grouped plurality of entries.

20. The method of claim 19, wherein the dataset is transmitted to a first device.
